(19) United States
(12) Patent Application Publication
(10) Pub. No.: US 2026/0058142 A1
(43) Pub. Date: Feb. 26, 2026

(54) METHOD FOR PRODUCING A BATTERY ACTIVE MATERIAL AND PRODUCT THEREOF

(71) Applicant: NOVONIX Anode Materials LLC, Chattanooga, TN (US)

(72) Inventor: Harrison A. Kreafle, Chattanooga, TN (US)

(21) Appl. No.: 19/102,270

(22) PCT Filed: Aug. 15, 2023
(86) PCT No.: PCT/US2023/072205

§ 371 Date: Feb. 7, 2025

Related U.S. Application Data
(60) Provisional application No. 63/373,015, filed on Aug. 19, 2022.
(60) Provisional application No. 63/489,367, filed on Mar. 9, 2023.
(60) Provisional application No. 63/504,982, filed on May 30, 2023.

(51) Int. Cl. H01M 4/587; C01B 32/205; H01M 4/02; H01M 10/0525

(52) U.S. Cl. CPC H01M 4/587; C01B 32/205; H01M 10/0525; C01P 2004/03; C01P 2004/50; C01P 2004/61; C01P 2006/12; C01P 2006/40; H01M 2004/021

(57) ABSTRACT

The present disclosure relates to the production of active materials that may be used in a battery anode and compositions thereof. The active materials may be composed of natural graphite or graphitizable primary particles that are agglomerated into secondary particles with an agglomeration solution. The resulting secondary particles may be carbonized and graphitized prior to their use as battery active materials.

### INCORPORATION BY REFERENCE TO ANY PRIORITY APPLICATIONS

This application claims the priority benefit of U.S. Provisional Application No. 63/373,015, filed Aug. 19, 2022, U.S. Provisional Application No. 63/489,367, filed Mar. 9, 2023, and U.S. Provisional Application No. 63/504,982, filed May 30, 2023, the entire disclosures of which are incorporated herein by reference in their entirety.

### BACKGROUND

Embodiments of the present application relate to anode materials comprising graphite and hard carbon and methods of making the same.

### DESCRIPTION OF THE RELATED ART

Graphite may be applied in various different technologies, including steelmaking, lubrication, carbon reinforced plastics, and batteries. Graphite is particularly useful as an anode material for various batteries, including lithium ion batteries, as it possesses two-dimensional sheets of carbon that allow intercalation of lithium ions for charging and discharging of the battery. Graphite has an exceptional ability to limit swelling upon lithiation or lithium intercalation, which results in reduced harm to the battery. This is a significant advantage in producing batteries that are sustainable and reusable for extended charge and discharge cycles.

Natural graphite may be obtained from natural sources and ore deposits. Natural graphite forms under intense heat and pressure over millions of years. On the other hand, synthetic graphite may be synthesized as the byproduct of various chemical processes. For example, synthetic graphite may be synthesized from petroleum, coal, or other synthetic or natural carbon materials. One such material that may be used to produce synthetic graphite is petroleum coke powder, which is a final byproduct in the oil refining process or coking process. Petroleum coke is a solid, non-melting carbon left over after coking where the heavy oils are cross-linked and evaporated out of the feed oil.

As discussed above, graphite possesses sheets of carbons, each sheet being a single atomic layer thick, which is comprised of aromatic rings of sp² hybridized carbons. Graphene is merely the isolation of a single layer of a graphite sheet from a graphite source. Graphite is useful in battery materials as it is exceptionally conductive and effectively facilitates charge and discharge without causing additional side reactions or other harm to the battery.

Synthetic graphite is desirable for lithium ion batteries due to its purity, performance, and consistency. As an anode material, synthetic graphite enables better cycling stability, faster charging, higher quality consistency, and fast production scalability. However, traditional methods for producing anode active materials using synthetic graphite have not been environmentally friendly. For example, various harmful chemicals have been used in the process of making artificial graphite active materials and granules thereof. Some of the chemicals that have been used are asphalt pitch, pitch coke, coal tar, fluoranthene, pyrene, chrysene, phenanthrene, anthracene, naphthalin, fluorine, biphenyl, or acenaphthene. These chemicals may be harmful to produce and use, and they may present additional environmental harm or environmental considerations when the battery is recycled at the end of its usable life.

Specialized equipment has also been necessary to produce a synthetic graphite anode material, and many traditional processes for creating synthetic graphite have used oxidative pre-treatments of the graphite precursors, which entails additional environmental harm, energy, and cost.

Therefore, there is a need to produce graphite materials or graphite-containing battery active materials through environmentally friendly methods that are cost-effective, more efficient than previous methods and do not require additional specialized equipment or treatments.

### SUMMARY OF THE INVENTION

Embodiments of the present invention enable the agglomeration or granulation of artificial carbon powders via an agglomeration solution. In various embodiments the agglomeration solution is environmentally friendly, cost-effective, and can result in an anode material that is electrochemically stable. The use of organic molecules, such as lignin, sugar, or plant-derived carbohydrates, in an agglomeration solution enables adhesion of the primary particles to each other through processing to maintain a secondary particle structure, and the secondary particle structures may be produced on readily accessible equipment. Due to the improvements disclosed herein, high-quality synthetic graphite may be produced in a cost-effective manner and incorporated into batteries optimized for electric vehicles, energy storage infrastructure, personal electronic devices, and many other devices.

The agglomeration of primary particles, resulting in secondary particles and ultimately graphitized anode materials, produces many benefits. One reason for agglomerating graphite in battery anodes is this allows for more efficient storage of lithium, sodium or other ions, which can improve the overall capacity and energy density of the battery. Agglomerating graphite in battery anodes can improve the performance and manufacturability of the batteries, making them more suitable for a wide range of applications.

For purposes of summarizing advantages achieved over the prior art, certain objects and advantages of the disclosure are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Various embodiments disclosed herein relate to a method for producing a battery anode active material or electrochemical active material. In various embodiments the battery active material may be comprised of synthetic soft carbon sprayed or coated with an agglomeration solution comprised of organic molecules such as lignin, sugar, or plant-derived carbohydrates. The agglomerated particles may be termed secondary particles that are carbonized and graphitized in order to be used as an anode material in a lithium ion or sodium ion battery. The lithium ion battery may be a Lithium Cobalt Oxide (LiCoO2 or LCO) battery, Lithium Manganese Oxide (LiMn2O4 or LMO) battery, Lithium Iron Phosphate (LiFePO4 or LFP) battery or variants of Lithium Iron Phosphate, Lithium Nickel Manganese Cobalt Oxide (LiNiMnCoO2 or NMC) battery, Lithium Nickel Cobalt Aluminum Oxide (LiNiCoAlO2 or NCA) battery, or Lithium Titanate (Li4Ti5O12 or LTO) battery.

The methods and product disclosed herein allow for the production of battery active materials that are carbon friendly, cost-effective, and require minimal pre-and post-granulation steps. The use of a lignin or plant-derived carbohydrate solution allows the agglomeration of secondary particles or battery active materials in a cost-effective manner, as lignin or plant-derived carbohydrates are widely available, lignin and carbohydrates being one of the most commonly occurring organic substances on earth, other than cellulose and hemicellulose, which may also be employed as organic molecules herein. Lignin and plant-derived carbohydrates are also easy to source and do not produce toxic or environmentally deleterious byproducts. The disclosed embodiments prevent the use of coal tar pitch or other harmful binders as an agglomeration product, which reduces the environmentally unfriendly impact of the production of anode active materials.

In some aspects, the techniques described herein relate to a method of making an electrochemical active material including: providing primary particles including soft carbon or natural graphite; adding the primary particles into a mixing system; adding an aqueous agglomeration solution with organic molecules present in the solution at a concentration of about 0.1 wt % to about 40 wt % to the mixing system and the organic molecules are selected from a group consisting of lignin molecules, sugar molecules, lignin-carbohydrate complexes, and plant-derived carbohydrates; and mixing the agglomeration solution and the primary particles according to predetermined criteria to produce secondary particles having a particle diameter D50 of about 5 μm to about 1000 μm.

In some aspects, the techniques described herein relate to a method, wherein the primary particles are soft carbon selected from a group consisting of micronized petroleum coke powder, polyvinyl chloride, mesophase pitch, pitch coke, or coal coke.

In some aspects, the techniques described herein relate to a method, wherein the organic molecules are sugar molecules and the sugar molecules are present in the solution at a concentration of about 1 wt % to about 20 wt %.

In some aspects, the techniques described herein relate to a method, further including drying the secondary particles, wherein the organic molecules are present in the secondary particles at about 0.1 wt % to about 5 wt % on a dry weight basis.

In some aspects, the techniques described herein relate to a method, wherein the mixing system is a high-shear mixing system or a fluidization system.

In some aspects, the techniques described herein relate to a method, wherein a concentration of organic molecules is varied throughout the mixing whereby the organic molecule concentration is varied by a total agglomeration solution addition as a ratio of the primary particles used in agglomeration.

In some aspects, the techniques described herein relate to a method, wherein the agglomeration solution has a pH in the range of about 7 to 10 and the organic molecules include at least one of ammonium lignosulfonate, sodium ligninsulfonate, soda lignin, dealkaline lignin, sucrose, ribose, riboside, glucose, glucoside, mannose, mannoside, galactose, galactoside, talitol, taloside, rhamnitol, rhamnoside, maltose, maltoside, lactoside, lactoside tetraacetate, 2,3-desoxy-2,3-dehydrolactoside, 2,3-desoxy-2,3-dehydrolactoside pentaacetate, 2,3-desoxylactoside, glucouronate, N-acetylglucosamine, fructose, sorbose, 2-deoxygalactose, 2-deoxyglucose, maltulose, lactulose, palatinose, leucrose, trehalose, gentiobiose, isomaltose, maltulose, turanose, lactose, mannitol, sorbitol, dulcitol, xylitol, 1-aminosorbitol, isomaltitol, cellobiitol, lactitol, maltitol, and fructose.

In some aspects, the techniques described herein relate to a method, wherein the organic molecules are lignin molecules and include at least one of ammonium lignosulfonate, sodium ligninsulfonate, soda lignin, and dealkaline lignin.

In some aspects, the techniques described herein relate to a method, wherein the primary particles have a particle diameter D50 between about 5 μm and about 15μm and the secondary particles have a particle diameter D50 between about 10 μm and about 30μm.

In some aspects, the techniques described herein relate to a method, wherein the agglomeration solution is an unsaturated solution.

In some aspects, the techniques described herein relate to a method, wherein the secondary particles are one of spherical, oblong, oval, or almond shaped and have a BET surface area less than about 10 m2/g.

In some aspects, the techniques described herein relate to a method, further including heating the secondary particles to form an electrochemical active material.

In some aspects, the techniques described herein relate to a method, wherein the heating includes carbonizing between about 800° C. and about 1200° C. followed by graphitizing between about 2600° C. and about 3000° C.

In some aspects, the techniques described herein relate to a method, wherein the electrochemical active material includes a matrix of soft carbon and hard carbon, wherein a ratio of soft carbon to hard carbon is between about 70:30 and about 99.5:0.5.

In some aspects, the techniques described herein relate to a method, wherein the ratio of soft carbon to hard carbon is between about 97.5:2.5 and about 99.5:0.5.

In some aspects, the techniques described herein relate to a method, wherein substantially all of the hard carbon content is derived from the organic molecules.

In some aspects, the techniques described herein relate to a method, wherein the electrochemical active material has a specific capacity greater than about 300 mAh/g in a battery half-cell.

In some aspects, the techniques described herein relate to a method, wherein the electrochemical active material has a discharge capacity greater than about 340 mAh/g in a lithium-ion battery half-cell.

In some aspects, the techniques described herein relate to a method, wherein both the primary particles and the secondary particles are not doped with additional inorganic particles.

In some aspects, the techniques described herein relate to a method, wherein the predetermined criteria include one or more of a speed of a high-shear granulation pan, a speed of a high-shear granulation mixing rotor, a residence time in the mixing system, an airflow speed, a nozzle spray interval, and a nozzle spray volume.

In some aspects, the techniques described herein relate to a method, wherein the agglomeration solution is sprayed into the mixture via a nozzle at a rate of about 12 mL/min per 500 grams of the primary particles and the agglomeration solution contains about 2 to about 30 wt % solids.

In some aspects, the techniques described herein relate to a method, wherein the primary particles have not been subjected to an oxidation treatment or graphitization treatment prior to being added to the mixing system.

In some aspects, the techniques described herein relate to a method, wherein the primary particles are natural graphite.

In some aspects, the techniques described herein relate to a method, wherein the organic molecules are sugar molecules and include at least one of a plant-derived monosaccharide, disaccharide, and polysaccharide.

In some aspects, the techniques described herein relate to an electrochemical active material including: an artificial secondary particle including one or more graphitized primary particles agglomerated together, the artificial secondary particles having a hard carbon content between about 0.2 wt % and about 4 wt %; and wherein the artificial secondary particles have a D50 between about 5 μm and about 50 μm; wherein the hard carbon content includes carbonized organic molecules and the organic molecules are selected from a group consisting of lignin molecules, sugar molecules, lignin-carbohydrate complexes, and plant-derived carbohydrates.

In some aspects, the techniques described herein relate to an electrochemical active material, wherein the artificial secondary particle has a BET surface area less than about 10 m2/g.

In some aspects, the techniques described herein relate to an electrochemical active material, wherein the organic molecules include at least one of monosaccharides, disaccharides, or polysaccharides.

In some aspects, the techniques described herein relate to a battery including: an anode active material produced, a cathode active material; and a liquid electrolyte.

In some aspects, the techniques described herein relate to a battery, wherein the battery is a lithium-ion battery or a sodium ion battery.

### BRIEF DESCRIPTION OF THE DRAWINGS

FIG. 1 shows a SEM image of an example agglomerated electrochemical active material with a scale of 50 microns.

FIG. 2 shows an SEM image of an agglomerated electrochemical active particle with a scale of 10 microns.

FIG. 3 shows a depiction of a high-shear mixing system with a counter rotating pan.

FIG. 4 shows a depiction of a fluidized bed reactor.

FIG. 5 shows a depiction of an additional fluidized bed reactor.

FIG. 6 shows a depiction of a flow diagram method according to embodiments herein.

### DETAILED DESCRIPTION

Disclosed herein includes methods of making an electrochemical active material containing graphite. The electrochemical active material is comprised of secondary particles that may be agglomerated according to various methods disclosed herein. In some aspects, the agglomerated particles are comprised of graphitic primary particles that are subjected to mixing with an agglomeration solution. The graphitic primary particles may be natural graphite or soft carbons that may be converted to graphite in a graphitization process. The agglomeration solution may be comprised of a solvent with particles, such as organic particles, dissolved therein. In some instances, the agglomeration solution may be an aqueous solution with organic molecules dissolved therein.

In some aspects the agglomeration or mixing takes place in a mixing chamber configured to agglomerate the primary particles having been exposed to the agglomeration solution. In some embodiments the mixing or agglomeration takes place in a high-shear or a fluidization environment. For example, the mixing chamber may be a high-shear mixing chamber or a fluidization chamber. The agglomeration process may take place in these systems continuously or produce secondary particles in a batch-wise manner.

In a typical embodiment the use of an aqueous agglomeration solution with plant-derived organic molecules facilitates the agglomeration of secondary particles that are equivalent or superior in quality compared to conventionally derived secondary particles that are produced according to conventional agglomeration processes. Further, the use of plant-derived organic molecules allows for a greater cost reduction as well as an environmentally friendly process that does not produce harmful or toxic byproducts.

In embodiments described herein the precursor powder for secondary particles or anode active materials may be composed of synthetic or natural materials. Synthetic materials may include, without limitation, compositions that are produced via synthetic processes or are the byproduct of chemical refining processes, such as powder derived from petroleum coke or coal tar. Synthetic graphite may be distinguished from natural graphite, although natural graphite materials may be substituted with synthetic graphite materials of the present disclosure. Similarly, the precursor powder may be a mixture of synthetic and natural graphite. Synthetic materials may also be termed artificial materials. In some embodiments the graphitization step may be omitted, and the secondary particles are subjected to a carbonization heat treatment.

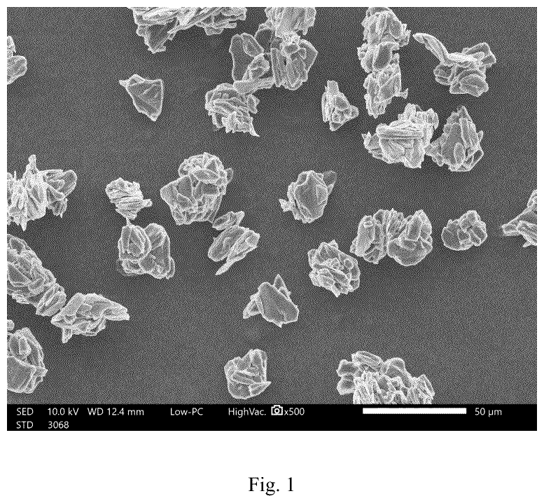

With regard to FIG. 1, FIG. 1 depicts an example Scanning Electron Microscopy image of an agglomerated electrochemical material produced according to methods disclosed herein. The lower right corner of the image shows a scale of 50 microns, thus showing that agglomerated secondary particles produced in embodiments of this disclosure may have diameters less than 50 microns. The agglomerated particle may be comprised of multiple primary particles that are agglomerated together. The image parameters are SED: 10 kV; WD: 12.4 mm; and STD: 3068.

Some embodiments herein may refer to the “average particle size” of the primary or secondary particles. The average particle size should be given its ordinary meaning as it would be understood by a person having ordinary skill in the art at the time of the invention but often refers to the average of the greatest dimension of at least 20 random particles as directly observed by SEM and measured with a laser scattering particle size analyzer.

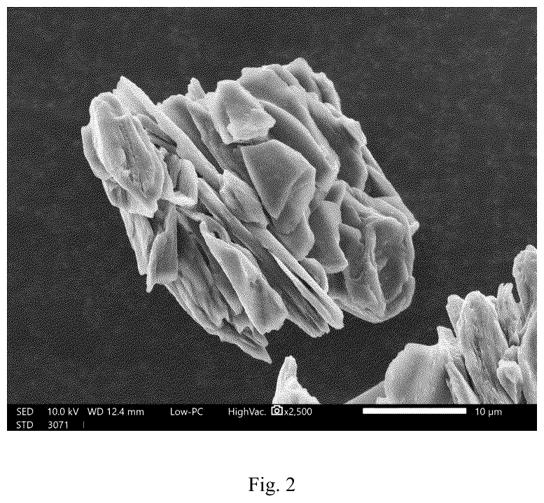

FIG. 2 depicts an example Scanning Electron Microscopy image of an agglomerated secondary electrochemical particle produced according to methods disclosed herein. The lower right corner of the image shows a scale of 10 microns. The image parameters are SED: 10 kV; WD: 12.4 mm; and STD: 3071.

In embodiments of the disclosure herein the electrochemical particle may be comprised of secondary particles that are heated, carbonized, and/or graphitized at elevated temperatures and may be employed as anode materials in a lithium ion battery. The secondary particles are comprised of two or more primary particles and are agglomerated, granulated, or held together prior to heating via an agglomeration solution. The primary particles may be provided in a high-shear mixing system or a fluidization bed and the agglomeration solution may be applied to the particles batch-wise or continuously. The agglomeration solution contains particles therein that facilitate the agglomeration and binding together of primary particles. The electrochemical or secondary particles may be viewed via SEM and measured with a laser scattering particle size analyzer to determine physical characteristics, such as average or median particle diameter size.

As mentioned above, an “agglomeration solution” is used to agglomerate primary particles. An “agglomeration solution” should be given its ordinary meaning as understood by a person having ordinary skill in the art, but may include, without limitation, homogeneous or heterogeneous solutions comprising agglomeration particles dissolved or dispersed in a solvent, an aqueous (water) solution, an alkaline aqueous solution, a miscible solution, an immiscible solution, a semi-organic solution, a semi-aqueous solution, an acidic aqueous solution, a fluid or viscous solution, or a substantially aqueous solution. The dissolved or dispersed particles in the agglomeration solution may be organic molecules in embodiments disclosed herein. The term “organic” should be given its ordinary meaning as a person having ordinary skill in the art would understand it, but should include, without limitation, molecules that are almost entirely comprised of carbon, hydrogen, oxygen, nitrogen. Organic molecules are distinct from inorganic compounds, which include transition metals, post-transition metals, lanthanides, actinides, alkali metals, alkali earth metals, and metalloids of the periodic table. In some embodiments, the agglomeration particles may include lignin or lignin derivatives, sugar or sugar derivatives, or plant-derived carbohydrates.

In some embodiments sugar may be dissolved in the agglomeration solution to facilitate the agglomeration of primary particles according to the methods herein. The terms “sugar” or a “sugar solution” should be given their ordinary meaning as understood by a person having ordinary skill in the art, but may include, without limitation, molecules or formulations comprising monosaccharides, disaccharides, or polysaccharides of all kinds including dextrose, fructose, galactose, glucose, lactose, maltose, or sucrose. Sugar solutions may include or be formulated from beet sugar, brown sugar, cane juice crystals, cane sugar, castor sugar, coconut sugar, confectioner's sugar, corn syrup solids, crystalline fructose, date sugar, demerara sugar, dextrin, diastatic malt, ethyl maltol, florida crystals, golden sugar, glucose syrup solids, grape sugar, maltodextrin, muscovado sugar, panela sugar, raw sugar, table sugar, sucanat, turbinado sugar, yellow sugar, agave nectar/syrup, barley malt, blackstrap molasses, brown rice syrup, buttered sugar/buttercream, carob syrup, corn syrup, evaporated cane juice, golden syrup, high-fructose corn syrup, honey, invert sugar, malt syrup, maple syrup, molasses, rice syrup, refiner's syrup, sorghum syrup, or treacle. Sugar may generally be described on a molecular level as any molecule of the general formula Cₙ(H₂O)ₙ, where “n” may be any integer 1, 2, 3, 4, etc.

Unless otherwise stated it should be assumed that the methods performed herein are performed at standard temperature and pressure of 25° C. and 1 atmosphere. Unless indicated otherwise, parts are parts by weight, temperature is in ° C., and pressure is in atmosphere.

The phrases “consisting essentially of” or “consists essentially of” are to be interpreted as limiting to the specified materials or steps involved (depending on context) but also to include-and not to exclude-any materials or steps that do not materially affect the basic and novel characteristics of the materials or steps involved.

Carbon sources may be referred to as “hard carbons” or “soft carbons.” These terms herein do not refer to mineralogical hardness, but rather to the ability of carbons to be converted to graphite. Hard carbons generally will not become graphitized and may have an amorphous structure. On the other hand, soft carbons possess the ability to become graphite or be graphitized. In some embodiments, hard carbons may also be referred to as char, charcoal, or non-graphitizing carbon.

In various embodiments the soft carbons may be comprised of “artificial” particles. This term may be given its ordinary meaning as a person having ordinary skill in the art would understand it, however it should include without limitation particles that are artificial or synthetic or artificially isolated, such as artificial graphitic particles that are composed via synthetic processes or is the byproduct of chemical refining processes or chemical separation processes, such as powder derived from petroleum coke or coal tar. Synthetic graphite may be distinguished from natural graphite, although natural graphite materials may be substituted with synthetic graphite materials of the present disclosure. “Graphitic” particles may also be referenced in various embodiments and generally relate to particles that are composed of graphite or may be converted to graphite via heating in a graphitization process.

In some embodiments herein the agglomeration solution may be an “alkaline solution.” This term should be given its ordinary meaning as a person having ordinary skill in the art would understand it, but it could be construed, without limitation, as a solution having a pH of 7 or higher. In various embodiments the alkaline solution may have a pH of at least about 7, at least about 7.5, at least about 8, at least about 8.5, at least about 9, at least about 9.5, at least about 10, at least about 10.5, at least about 11, or any range in between. An alkaline solution may be formed by adding any molecules that which increase the concentration of OH⁻ (under the Arrhenius definition) in an aqueous solution, have a higher affinity for a proton (under the Bronstead definition), or which are electron donors in an aqueous environment (under the Lewis definition). In various embodiments the primary solvent in the solution is water, but there may be additional components and/or solvents mixed into the solution. For example, the solution may have a miscible solvent or other additive that reduces the polarity of the solution. In at least one embodiment the solvent is an aqueous alkaline solution.

In embodiments herein the agglomeration solution may be a “dispersion.” This term should be given its ordinary meaning, as a person having ordinary skill in the art would understand it, but may include, without limitation, solutions, homogeneous dispersion, heterogeneous dispersions, colloids, or suspensions. The dispersions may be dispersions in any solvent, but the dispersions are typically aqueous dispersions. The solvent may be a polar or nonpolar solvent.

In some embodiments or examples herein the agglomeration solution may contain “lignin.” Lignin is generally derived from plant sources, is a complex polymer that is found in the cell walls of many plants and is the second most abundant organic material on earth after cellulose.

Lignin is beneficial as it reduces the costs of artificial graphite production, reducing the costs of the battery cell, yet does not produce adverse reactions with the artificial primary particles or the resulting graphitized anode material. Lignin may be synthesized, but is generally isolated from lignocellulose, which is made up of cellulose, hemicelloluse, and lignin. Lignin may take a variety of forms as lignin is a collection of highly heterogeneous polymers derived from a handful of precursor lignols. The heterogeneity of the lignin arises from the diversity and degree of crosslinking between these lignols.

There are generally three main types of lignin, known as H, G, and S lignin. These types of lignin differ in their chemical structure and are characterized by the type of monolignol units that make up their polymer chains. The G unit is coniferyl alcohol (4-hydroxy-3-methoxyphenylpropane) and its radical is sometimes called guaiacyl. The S unit is sinapyl alcohol (3,5-dimethoxy-4-hydroxyphenylpropane) and its radical is sometimes called syringyl. The H unit is paracoumaryl alcohol (4-hydroxyphenylpropane) and its radical is sometimes called 4-hydroxyphenyl. H lignin is primarily composed of H units and is typically found in grasses and some dicotyledonous plants. G lignin is primarily composed of G units and is the most common type of lignin found in woody plants. S lignin is primarily composed of S units and is typically found in the secondary cell walls of hardwoods. Additionally, there are intermediate forms of lignin that contain a combination of H, G, and S units, and the exact composition of lignin can vary depending on the plant species and the tissue type. An intermediate isolated lignin may be termed a GS-lignin, where the lignin is mainly composed of G-S monomeric units and may have a minor portion or insubstantial portion of H units. Other isolated lignins may be HSG lignins, SH-lignins, or HG-lignins. Lignin can also undergo modifications such as hydroxylation, methylation, and acetylation, which can affect its properties and functions. Therefore, embodiments in the present disclosure envision the use of hydroxylated, methylated, or acetylated lignin or other modifications or functionalizations of lignin.

Lignin is generally insoluble in a neutral aqueous solution. In terms of Kₛₚ, this means that its Kₛₚ is less than 1, and is generally much less than one in a neutral aqueous solution where the pH is approximately 7, or in a solution with the pH in a range of 6.5 to 7.5. However, the solution or the lignin may be modified to increase the solubility of the lignin such that its Kₛₚ is greater than one or much greater than one such that a significant amount of lignin dissolves in the aqueous solution. For example, lignin can be solubilized by treating it with alkaline solutions such as sodium hydroxide or sodium sulfite. The resulting solution, known as alkaline lignin, can be used as a feedstock for embodiments of the present disclosure. Alternatively, lignin can be solubilized by treating it with acid, such as sulfuric acid. The acid hydrolysis process breaks down the lignin polymer into smaller fragments, resulting in a soluble lignin product that can be used in embodiments disclosed herein. Further, certain enzymes, such as laccases or peroxidases, can be used to modify the lignin structure, resulting in a more soluble product. Enzymatic treatment can be used in combination with other methods to improve the lignin solubility in embodiments disclosed herein. The embodiments disclosed herein envision the modification of any lignin molecules, such as the breaking down of the lignin polymer into smaller fragments, or the modification or lignin to increase the polarity of the lignin molecules to increase their solubility in an aqueous or otherwise polar solvent.

In some embodiments or examples disclosed herein the lignin may be dissolved through acidic treatment, basic treatment, enzymatic treatment, or through functionalization or modification. In various embodiments the lignin may be dispersed alkaline lignin, which is sometimes known as lignosulfonate. Lignosulfonates are a group of lignin-based products that are produced through alkaline extraction of wood and other lignocellulosic materials. The alkaline extraction process involves treating the lignocellulosic material with a strong base such as ammonia, sodium hydroxide, or sodium sulfite, which breaks down the cell walls and releases the lignin. The resulting lignin is then modified to produce lignosulfonates, which are water-soluble polymers that have a wide range of industrial applications. Alkaline dispersed lignin has a negatively charged surface, making it quite soluble in water and capable of forming stable dispersions in aqueous media. The lignosulfonate used in various embodiments disclosed herein may be an ammonia lignosulfonate.

In assessing the particles, particle size distribution and sphericity may be determined by any suitable known technique such as by SEM, optical microscopy, dynamic light scattering, laser diffraction, manual measurement of dimensions using an image analysis software, for example from about 15 to about 30 measures per image over at least three images of the same material section or sample, and any other techniques.

Particle size distribution as referred to herein may be stated in terms of “D50” or in terms of average particle size. Average particle size may be calculated as the average of the distribution of particles. D50 is also called as the median particle diameter or median particle size. For example, for a powder sample with D50=about 5 μm, it means 50% of particles are larger than about 5 μm and 50% particles are smaller than about 5 μm. In some embodiments the D50 may be assessed as a sample size of an SEM image, such as assessing D50 as a median particle size of 20 or more particles, or measured with a laser scattering particle size analyzer.

In some embodiments, the D50 of the secondary particles may be between about 1 and about 1000 microns, between about 1 and about 900 microns, between about 1 and about 700 microns, between about 1 and about 600 microns, between about 1 and about 500 microns, between about 1 and about 400 microns, between about 1 and about 300 microns, between about 1 and about 200 microns, between about 1 and about 100 microns, between about 1 and about 75 microns, between about 2 and about 40 microns, between about 5 and about 30 microns, between about 5 and about 20 microns, or between about 5 and about 15 microns. In one typical embodiment the secondary particles have a diameter between about 10 and about 30 microns. In some embodiments the secondary particles may be spherical in shape, or substantially spherical. In at least one embodiment the secondary particles may be substantially spherical, oblong, oval, or almond shaped. The process described herein may provide secondary particles that are a variety of shapes, such as mixtures of substantially spherical, oblong, oval, almond, or cluster-shaped particles.

An agglomerated spherical, oval, oblong, or almond configuration of the secondary particles and the anode active material may facilitate the charge and discharge capabilities of the material. For example, the spherical or agglomerated shape of the secondary particles may enhance filling properties and thereby enable the formation of an active material layer having a high density and an increase in capacity.

In some embodiments the D50 of the primary particles may be between about 1 and about 75 microns, between about 1 and about 50 microns, between about 1 and about 45 microns, between about 1 and about 30 microns, between about 1 and about 20 microns, between about 1 and about 15 microns, between about 1 and about 10 microns, or between about 1 and about 5 microns. In one typical embodiment the primary particles have a diameter between about 1 and about 15 microns.

In various embodiments the average particle size or D50 of the secondary particles may be approximately double the D50 of the primary particles. Processes and embodiments disclosed herein enable the agglomeration or granulation of primary particles into secondary particles via an agglomeration solution with organic molecules, such as a lignin solution, a sugar solution, or a solution with non-graphitizable carbons. The solution facilitates the clustering, clumping, granulation, or agglomeration of primary particles together and functions as a non-graphite or non-graphitizable hard carbon in the resulting anode active material.

The agglomeration solution described herein may have a concentration stated in terms of weight percentage or volume percentage. Unless otherwise indicated the parts indicated are parts by weight. The solutions in embodiments disclosed herein, such as aqueous solutions, may have organic molecules such as lignins or sugars dissolved in a higher percentage by increasing the temperature of the agglomeration solution. In various embodiments the agglomeration solution may be heated such that it is at least about 22 degrees Celsius, at least about 25 degrees Celsius, at least about 28 degrees Celsius, at least about 30 degrees Celsius, at least about 40 degrees Celsius, at least about 50 degrees Celsius, at least about 60 degrees Celsius, or any other range in between. The agglomeration solution with lignin molecules may have increased solubility with ammonium lignosulfonate dissolved therein, with sodium ligninsulfonate dissolved therein, or with alkaline lignin dissolved therein. Previously lignin has not been used as an agglomeration material due to its low solubility in an aqueous solvent. The inventors of this disclosure have discovered that lignin may be used as an agglomeration material for an anode active material, which is advantageous and unexpected in view of the teachings of the prior art.

In various embodiments the agglomeration solution may have a concentration between about 0.1 wt % and about 40 wt %, between about 1 wt % and about 30 wt %, between about 1 wt % and about 20 wt %, between about 2 wt % and about 18 wt %, between about 2 wt % and about 15 wt %, between about 2 wt % and about 12 wt %, or between about 8 wt % and about 10 wt %. In a typical embodiment the agglomeration solution is a solution with organic molecules dissolved therein, such as lignin, sugars, or plant-derived carbohydrates, and the solution contains between about 7 wt % and about 15 wt % lignin molecules. In various embodiments the organic molecules are plant-derived lignins, sugars, or carbohydrates.

The solution provided may be substantially pure to decrease contamination in the anode active material and promote clean operation of the anode active material. Removing impurities, such as metals, in the solution may facilitate fewer side reactions or catalyzed side reactions in the anode active material or the resulting battery cell. In various embodiments the solution may comprise an acidic aqueous solution, a basic aqueous solution, an organic or nonpolar solution, reverse osmosis water, ultra-pure water, neutralized water, chemically filtered water, ion exchange water, water purified through a carbon block, water purified through activated charcoal, or spring water. In various embodiments the water may be readily accessible tap water. In embodiments disclosed herein the water may have total dissolved solutes (TDS) less than about 500 ppm, less than about 400 ppm, less than about 300 ppm, less than about 200 ppm, less than about 100 ppm, or less than about 50 ppm.

In various embodiments the primary particles and the agglomeration solution may be mixed and granulated via high-shear mixing. The high-shear mixing system may take a variety of forms, and suitable high-shear mixing, and agglomeration may be performed with a batch high-shear system, in-line high-shear system, powder injection high-shear system, a high-shear granulator, or a powder injection high-shear mixer. Batch high-shear mixers can process large volumes in a shorter period. In-line mixers, on the other hand, are less prone to contamination and can be controlled more effectively. In general, the high-shear system provides high shearing forces to the particles in the system. In general, the two main parts of a high-shear mixer are the rotor and the stator, which may be referred to as the mixing head or generator. The region between the rotor and the stator, known as the shear gap, is a significant region where the mixture is being sheared. Thus, the mixing may be called “high-shear mixing.” In some embodiments the rotor may accelerate the fluid tangentially, and the inertia of the fluid keeps it from flowing together with the rotor. The fluid may flow towards the shear gap or the region between the rotor tip and the stator. Inside the shear gap, high velocity differentials and turbulent fluid flow may be present, producing high-shear rates.

In embodiments of high-shear mixing, the system should facilitate the mixing and agglomeration of primary powder particles and the addition of an agglomeration media or solution to produce secondary particles. The system may facilitate the stepwise introduction of an agglomeration solution or the continuous addition of the agglomeration solution to the primary particles. The system may be adapted to change the type and concentration of the agglomeration solution in order to provide varying amounts or varying concentrations of lignin, sugar, or plant-derived carbohydrate molecules. For example, a highly concentrated agglomeration solution may be provided in the initial stages of mixing and agglomeration followed by a less concentrated solution, or vice versa. Concentration of the agglomeration solution may be regulated or adapted based upon other parameters of the high-shear system, such as air flow, speed of the mixing pan and the mixing rotor and the residence time at various mixing conditions.

The high-shear mixer parameters may be optimized to facilitate primary particles of a particular size or secondary particles having a predetermined size. For example, the primary particles may be processed or selected such that they have particle diameters (D50) in the range of about 1 micron−about 100 microns. The secondary particles may also be agglomerated such that they have a predetermined diameter (D50) in the range of about 1 micron to about 100 microns. The predetermined diameter may depend upon the use case of the secondary particles as an anode active material. For example, larger particles may be optimal in a specific battery cell with a predetermined electrochemical potential. The size of the secondary particles may be based upon the charge/discharge characteristics of the battery cell.

Further, the secondary particles or resulting anode active material may be size controlled based upon the type of ions or metals that are charged or discharged from the artificial graphite layers. For instance, the size of the secondary particles may be controlled based upon whether lithium ions/atoms, sodium ions/atoms, or other metal ions/atoms are configured to intercalate or deintercalated with the graphite layers of the anode active material.

The high-shear granulation may proceed with or without size reduction of the primary particles. In various embodiments the micrometer primary particles may be sieved, and size controlled into a narrow size distribution prior to being placed into the high-shear granulation system. In some embodiments the primary particles may be larger particles that are broken down or sheared via the high-shear system before the agglomeration media is added to the system.

A high-shear system may optimally facilitate the agglomeration or granulation of primary particles. The agglomeration process may be described as a process of spraying or coating the particles with a solution, moistening the particles with the solution as they form into conglomerates, and solidifying the agglomerated particles with partial or full removal of the agglomeration solution via heating.

Agglomeration time in a high-shear system is generally dependent on system parameters but may be at least about 30 seconds, at least about 1 minute, at least about 3 minutes, at least about 5 minutes, at least about 10 minutes, at least about 20 minutes, at least about 30 minutes, at least about 45 minutes, at least about 1 hour. In an embodiment the residence time is between about 5 and about 30 minutes.

Parameters of the high-shear mixing system may be adjusted before or during operation. For example, the speed of a mixing pan and the rotor may be adjusted relative to one another or relative to the residence time, and the residence time at each mixing condition may be altered. Where the mixing and agglomeration results in oversized particles the oversized particles may be removed via a classification system and downsized to a target size. In a typical embodiment the target size of the secondary particles is 10 to 30 microns (μm).

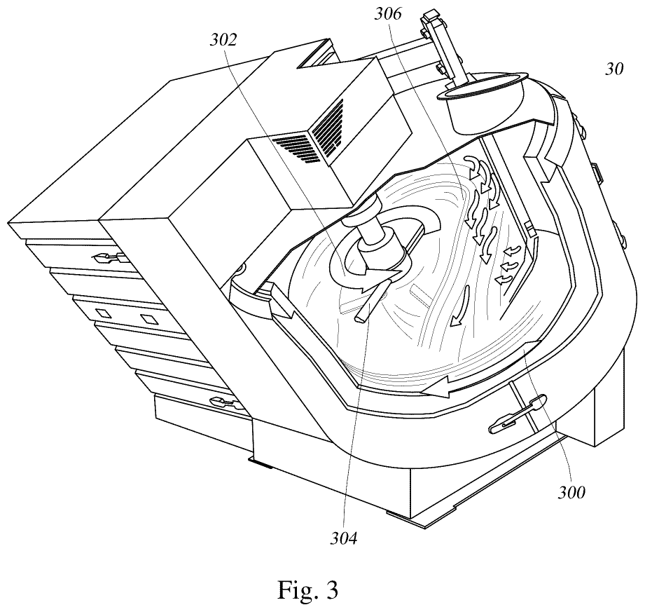

FIG. 3 depicts a high-shear granulation system 30 with a rotating mixing pan 300. The high-shear granulation system 30 mixes material 306 with rotors 304 that move in a counterrotating direction 302. Thus, the material 306 experiences a shear force as the material 306 encounters the shear rotors 304. The high-shear granulation system 30 shown here may be tilted such that gravity may be used to rotate the material in a circular or oval vortex. In various embodiments the mixing chamber of the high-shear mixing system may include ambient air, reduced-oxygen ambient air, nitrogen gas, helium, argon, or other inert gasses. In some embodiments the air may be filtered air to remove residual gasses or vapor elements and provide increased purity for the mixing process.

In this embodiment of the agglomeration process the rotors 304 and mixing pan 300 are initially set for counter rotation. The speed may be set to about 5% of maximum speed (about 5 to about 10 revolutions per minute or RPM's) while the total soft carbon material 306 is loaded into the mixer through the dosing port. The loading of the soft carbon material 306 should occupy greater than about 30% of the mixer volume but less than about 80%. The mixer speed is then increased to about 50% of the total mixer speed, (about 40 to about 60 RPM's). At this point, the hard carbon forming agglomeration solution (which may comprise organic molecules such as lignin, sugar, or plant-derived carbohydrates and is generally specified based on final concentration) is added slowly to the mixture and becomes a portion of the mixing material 306. The addition of the agglomeration solution occurs over the course of at least about 30 seconds, at least about 1 minute, at least about 2 minutes, at least about 3 minutes, or at least about 5 minutes. In a typical embodiment the agglomeration solution is added over a period of about 1 to about 2 minutes. After the total amount of the agglomeration solution is added to the system the mixer speed is increased to about 80% of the maximum speed (about 70 to about 90 RPM's). The agglomeration solution is more fully incorporated onto the soft carbon primary particles during this step. The material 306 may be mixed for a period of about 0.1 to about 10 minutes at this speed, but in a typical embodiment it is mixed for about 2 minutes, as two minutes of mixing are typically sufficient for incorporation. Thereafter the mixing can be optimized for micro-granulation. The rotation speed can be brought to about 10% of its maximum speed (about 10 to about 20 RPM's) which allows for a snow balling type effect on the agglomeration-rich precursor particles. Mixing at about 10% of maximum speed may vary and depend upon desired degree of agglomeration and micro-granule size. In some embodiments this mixing may be at least about 1 minute, at least about 2 minutes, at least about 5 minutes, at least about 7 minutes, at least about 10 minutes, at least about 15 minutes, at least about 20 minutes, or at least about 30 minutes. In a typical embodiment this portion of mixing is from about 2 to about 15 minutes. After the completion of this low-speed mixing the resulting powder is then discharged from the mixer for further processing. The agglomerated material may then undergo a carbonization step in an inert atmosphere or partially inert atmosphere to remove moisture and non-carbon elements. After carbonization the material may be graphitized, and the primary soft carbon particles are converted into carbon with a graphitic structure capable of lithium-ion intercalation and the hard carbon maintains an amorphous structure.

In a further embodiment the primary particles and an agglomeration solution may be mixed and agglomerated via fluidization. “Fluidization” should be given its ordinary meaning as understood by a person having ordinary skill in the art, but may include, without limitation, the process of converting a bed of solid particles into a fluid-like state by passing a gas through it. There are several types of fluidization, and some examples may include bubbling fluidization, turbulent fluidization, and circulating fluidization. The fluidization pressure may be high enough to counteract the force exerted on the particles by gravity such that they float, suspend, or respond fluidly in the fluidization bed.

Bubbling fluidization is a type of fluidization in which the gas bubbles rise through the bed of solid particles, causing the particles to become suspended and move around. This type of fluidization is typically used for small particles and low gas velocities. Bubbling fluidized bed reactors typically consist of a vertical vessel with a gas distributor at the bottom and a gas outlet at the top.

Turbulent fluidization is a type of fluidization in which the gas flows through the bed of solid particles at high velocities, causing the particles to become highly agitated and move around rapidly. This type of fluidization may be used for larger particles and higher gas velocities but may also be used for smaller particles that require thorough mixing, such as particles of the present embodiment.

Circulating fluidization is a type of fluidization in which the solid particles are lifted off the bottom of the bed by the gas and circulated throughout the bed. This type of fluidization may be used for large particles and high gas velocities. Circulating fluidized bed reactors typically consist of a vertical vessel with a gas distributor at the bottom, a gas outlet at the top, and a mechanism for lifting and circulating the solid particles.

In some embodiments the fluidization apparatus may be a spouted bed reactor. Spouted bed reactors may be employed for coating processes and may involve the suspension of solid particles in a gas stream. These reactors typically consist of a vertical vessel with a gas inlet at the bottom and a gas outlet at the top, and a mechanism for generating and controlling the flow of gas through the bed of solid particles.

In some embodiments the fluidization apparatus may be a fixed bed reactor. Fixed bed reactors may be useful for processes involving the contact of a gas or liquid with a bed of solid particles. These reactors typically consist of a horizontal or vertical vessel with a gas or liquid inlet at one end and a gas or liquid outlet at the other end.

In these fluidization systems at least one nozzle or port may be used to provide an agglomeration solution to the fluidized particles. In some embodiments the nozzle may be used to spray the agglomeration solution in a stepwise manner, continuously, or may be used to spray the agglomeration solution based upon the fluidization characteristics of the fluidization reactor, such as the air speed, circulation speed, temperature, agglomerated particle size, etc. In some embodiments two nozzles may be provided that are connected to agglomeration solutions of varying concentrations. Thus, each nozzle may provide an agglomeration concentration based upon residence time in the fluidization system, air speed in the reactor, temperature, desired particle size, desired hard carbon content, etc.

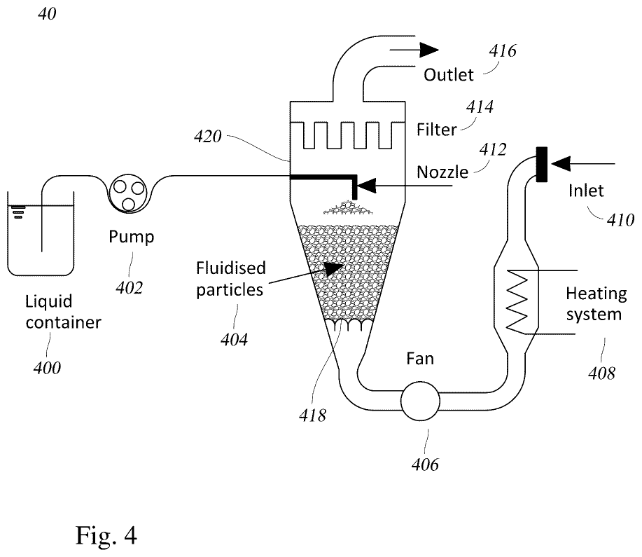

FIG. 4 depicts a fluidized bed system 40. In the system 40 pressurized air is sent through an inlet 410 to a heating system 408 which heats the air. The pressurized air may be ambient air, desiccated air, oxygen-reduced air, or an inert gas such as nitrogen gas, helium, argon, etc. A fan 406 may be used to pressurize the air through the conduit that leads to the fluidized bed surface 418 of the fluidized bed chamber 420. The pressurized air provides a fluidization force for the fluidized particles 404. As such, the fluidized particles 404, although they are solid particles, move with ease as if they were a fluid, which is why they are termed “fluidized particles.” A nozzle 412 provides an agglomeration, particle coating, or binder solution. The binder solution is held in a liquid container 400 and pumped to the nozzle 412 via a peristaltic pump 402. A filter 414 may be configured on the upper portion of the fluidized bed in order to prevent the escape of vapors or fluidized particles. The filter 414 may be connected to an additional membrane that selectively filters vapors or noxious gases from escaping via the air outlet 416. Alternatively, the membrane for gases or noxious vapors may be incorporated into the filter 414. After filtration, gas particles may be released via air outlet 416.

The system 40 may be modified while still providing the advantages above. For example, the pressurized air may be an inert gas, such as helium, nitrogen, argon, etc. The gas may be heated via the heating system 408, or the heating system may be turned off and the gas may be room temperature atmospheric gas. Further, the circulation of the fluidized particles may be facilitated by rotors, blades, counterrotating mixers, convection vents, conduits or other features in order to increase the homogeneity of the agglomeration or coating solution on the fluidized particles 404. The agglomeration solution may be heated in the liquid container 400 such that the amount of dissolved particles in the agglomeration solution may be increased. This further provides the advantage that the solution may be closer to the temperature of the fluidized particles 404 and the pressurized gas. The fluidization chamber 420 may be cylindrical, conical, frustoconical, or any other shape to facilitate fluidization or convection or circulation of the fluidized particles.

In an embodiment the primary particles or fluidized particles 404 are added to the fluidized bed chamber 420. The particles 404 are fluidized and allowed to reach temperatures between about 120 to about 130° F. before spraying begins.

The agglomeration solution (such as a solution containing lignin, sugar, or plant-derived carbohydrates) may be mixed together to create a solution containing about 1-70% solids by weight, about 3-20% solids by weight, about 3-15% solids by weight, about 8-15% solids by weight, at least about 3% solids by weight, at least about 5% solids by weight, at least about 8% solids by weight, at least about 10% solids by weight, at least about 15% solids by weight, at least about 20% solids by weight, at least about 30% solids by weight. The solids may be plant-derived organic molecules, such as sugars, plant-derived carbohydrates, or lignins, in the agglomeration solution. In one embodiment components of the agglomeration solution are heated to make the agglomeration solution containing between about 8 to about 30% solids by weight. The solution may be diluted if the composition is too viscous for spraying via nozzle 412. Alternatively, the material may be poured into the fluidization chamber 420 where a highly concentrated and viscous solution is desirable.

While the coating or agglomeration solution is being sprayed from the nozzle 412 the solution may be heated and/or stirred in the liquid container 400. The coating or agglomeration solution may be sprayed into the bed at a rate of 12 mL/min per 500 grams of primary particles or soft carbon particles until the desired amount of solution is dispensed. In some embodiments the coating of the particles may occur in several steps where varying concentrations or varying agglomeration materials may be dispensed. For example, a first agglomeration solution containing about 3%-about 10% solids may be dispensed followed by an agglomeration solution containing about 8%-about 12% solids. The nozzle may spray a fine mist or vapor of agglomeration solution, such as with an ultrasonic spraying nozzle. A temperature difference may be created such that the agglomeration solution is hotter or cooler than the temperature of the fluidized primary particles. The total amount of coating or agglomeration solution varies based on target concentration of soft carbon precursor to hard carbon forming binder on a dry basis. Defined amounts of the agglomeration solution are dispensed in order to achieve micro-granulation without overly wetting the precursor, which may create a mud like consistency. Thus, the dispensing of the agglomeration solution should be controlled in view of various process parameters such as temperature, fluidization rate and airflow, and desired particle size. After spraying is complete or a threshold wetting has been met, the resulting coating or agglomerated material was allowed to dry to about 125° F. before removal.

The fluidization of the agglomerated particles will, by virtue of the airflow around the fluidized material, cause most of the solvent or all of the solvent from the agglomeration solution to evaporate, leaving the lignin, sugar, or plant-derived carbohydrate molecules surround the primary particles. In some embodiments the airflow in the fluidization bed may be regulated to produce the desired amount of evaporation.

After the fluidized, granulated, or agglomerated particles containing hard and soft carbon are discharged they should contain a moisture content below about 0.25%. Thus, in some instances the particles may require further drying to reduce the overall moisture content below about 0.25%. The dried and agglomerated material may then be further processed through calcination and graphitization to produce a finalized composite electrochemical or anode material.

The agglomerated, calcinated, and graphitized anode material preferably has a D50 between about 10 μm and about 30 μm, a BET surface area less than about 10 m²/g, a ratio of soft carbon to hard carbon between about 97.5:2.5 and about 99.5:0.5, and a discharge capacity greater than about 340 mAh/g in a lithium-ion battery half-cell. In various embodiments the agglomerated particles are not doped with additional elements, such as silicon, and the primary particles are not subjected to an ozone treatment. In some embodiments the secondary particles are comprised of the elements carbon, oxygen, and hydrogen and exclude other metals or inorganic elements. In some embodiments the secondary particles consist essentially of the elements carbon, oxygen, and hydrogen and contain less than 1% of metals or inorganic elements.

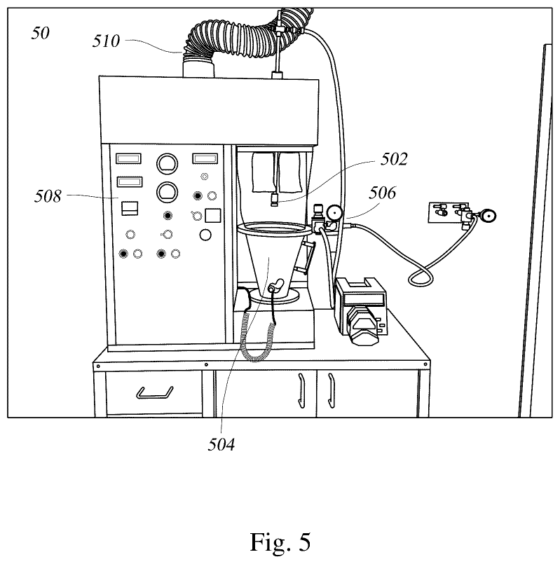

Referring to FIG. 5, a fluidization apparatus 50 is shown. This apparatus is analogous to the fluidization apparatus shown in FIG. 4. However, this apparatus may contain a gas pressure source 506 for dispensing an agglomeration solution via nozzle 502. The pressure source 506 may also be in the form of a peristaltic pump. The nozzle 502 may be a 35100 air atomization nozzle. The pressure source 506 regulates the pressure provided for the dispensing of the agglomeration solution. Fluidization chamber 504 is depicted with a frusto-conical shape, although other shapes or configurations are envisioned. An outlet 510 for the fluidization gases is provided on the top of the apparatus 50. Parameters of the fluidization process may be modified via a user input terminal 508. Temperature, airflow, nozzle dispensation rate, pressure, humidity, air source, agglomeration solution concentration, fluidization time, mixing or convection parameters (where mixing blades or conduits are utilized), and other parameters may be adjusted via terminal 508.

The system 50 may be modified while still providing the advantages above. In different embodiments fluidization chamber 504 may be configured such that the loading and removal of particles from the fluidization chamber 504 may be continuous. For example, a siphon may be provided in the fluidization chamber in the upper, middle, or lower portion of the fluidization chamber, which may depend upon the convection parameters. The siphon may be utilized to siphon off secondary particles with a predetermined density, coating threshold, or average particle diameter. At the same time a conduit may be connected to the fluidization chamber to input uncoated primary particles, such as micronized petroleum coke powder. Thus, in this manner a continuous agglomeration system may be achieved.

Agglomerated secondary particles may be removed from the mixing apparatus in a variety of ways including pouring out the particles, siphoning out the particles based upon density of the particles and settlement, sieving out the particles, batchwise removal of the particles in any of the methods described herein, pneumatic removal of the particles via a gas circulation system, or other particle removal methods known in the art. The particles may be removed after mixing and based upon the desired particle size. In a typical embodiment the agglomerated particles are removed after the particles have a particle diameter D50 of about 5 μm to about 1000 μm, preferably about 5 to about 30 μm.

The agglomeration solution, which may be a dispersed aqueous lignin solution or a sugar solution, may be incorporated via mixing. As discussed above, various drying and heating processes may remove substantially all of the liquid in the solution. Evaporation may take place in the high-shear mixing system or in the fluidization bed reactor. Evaporation may also take place in a heat treatment after removing the secondary particles from the mixing system. In a typical embodiment the heat treatment is a carbonization treatment performed between about 800 and about 1200° C. to set the particle structure followed by a graphitization treatment performed between about 2600° C. and about 3000° C. In the graphitization treatment the artificial coke particles are converted to graphite particles and the non-graphitizable lignin, sugar, or plant-derived carbohydrate molecules may be converted to hard carbon. After graphitization the resulting material is an electrochemical active material and may be termed an anode active material which may be incorporated into a battery cell for electrochemical processes.

In embodiments herein the graphitization and carbonization may take place in an inert or substantially inert environment or in the absence of water or oxygen. For example, the gasses in the carbonization and graphitization chamber may be N₂, CO₂, helium, argon, krypton, xenon or mixtures thereof. Alternatively, ambient air may be used that is desiccated or oxygen-depleted.

The carbonization treatment temperature for the secondary particles may exceed the decomposition temperature of the carbonized molecules, such as hard carbon forming organic molecules. In some embodiments TGA may be used to determine the decomposition temperature of the organic molecules. For example, the carbonization temperature may exceed the decomposition temperature of lignin, lignosulfonates, sucrose, glucose, fructose, dextrose, maltose, ribose, or any other synthetic or plant-derived carbohydrate.

The hard carbon content of the anode active material may vary according to the processes for creating the agglomerated secondary particles. For example, the hard carbon content may vary based upon the amount of agglomeration solution added to the mixture, the amount of drying during the process, the concentration of the agglomeration solution, and the final particle size and structure. In some embodiments the hard carbon content of the anode active material is between about 0.01 wt % and about 5%, between about 0.1 wt % and about 4 wt %; between about 0.2 wt % and about 4 wt %, between about 0.3 wt % and about 4 wt %, between about 0.5 wt% and about 2.5 wt %, between about 0.5 wt % and about 3.25 wt %, or between about 0.5 wt % and about 3 wt %. In a typical embodiment the hard carbon content is between about 0.3 wt % and about 2.5 wt % or preferably 1 wt % to 1.5 wt %. In some embodiments the hard carbon content in the anode active material may be stated in terms of minimum hard carbon content such as at least about 0.1 wt %, at least about 0.2 wt %, at least about 0.3 wt %, at least about 0.4 wt %, at least about 0.5 wt %, at least about 1 wt %, at least about 2 wt %, or at least about 3 wt %. In a typical embodiment the hard carbon content is at least 0.3 wt %. In embodiments disclosed herein the hard carbon content is substantially derived from the agglomeration solution and the artificial primary particles are substantially free of non-graphitizable hard carbons. In various embodiments all of the hard carbon is derived from the agglomeration solution composed of organic molecules such as lignin molecules, sugar molecules, or plant-derived carbohydrate molecules. These organic molecules may be carbonized or pyrolyzed such that they constitute hard carbon.

The ratio of soft carbon to hard carbon in the anode active material may vary, for reasons discussed above. It may be desirable to have more or less hard carbon depending upon the charge/discharge characteristics of the powder or the desired size of the secondary particles. The soft carbon/hard carbon ratio may be about 60:40, about 65:35, about 70:30, about 75:25, about 80:20, about 85:15, about 90:10, about 95:5, about 97:3, about 98:2, about 99:1, about 99.9:0.9 or any number in between. In a typical embodiment the ratio of soft carbon to hard carbon is about 97.5:2.5.

The structure of the agglomerated secondary particles may be verified throughout mixing or after mixing is complete. The size, shape, and surface area of the particles may be observed via SEM and surface area analysis, such as BET (Brunauer-Emmett-Teller) surface area, or measured with a laser scattering particle size analyzer. The volumetric surface area of the particles may vary depending upon the desired particle size, but in a typical embodiment the BET surface area of the secondary particles is less than about 10 m²/g. In some embodiments the volumetric surface area of the secondary particles may be less than about 20 m²/g, less than about 15 m²/g, less than about 12 m²/g, less than about 8 m²/g, less than about 6 m²/g, less than about 4 m²/g, or less than about 2 m²/g. In various embodiments the surface area of the secondary particles may be optimized in order to facilitate more sites for the intercalation of lithium or sodium ions. For example, the BET surface area or specific surface area of the secondary particles may be at least about 1 m²/g, at least about 2 m²/g, at least about 3 m²/g, at least about 4 m²/g, at least about 6 m²/g, at least about 7 m²/g, at least about 8 m²/g, or at least about 9 m²/g.

BET surface area is a measure of the total surface available for adsorption on porous materials. The determination of BET surface area may help understand the porosity, reactivity, and performance of materials. BET analysis assumes that gas molecules form a monolayer on the surface of the material at low relative pressures. As the pressure increases, additional gas molecules are adsorbed in multilayers on top of the monolayer. The theory provides a mathematical model to describe the adsorption behavior and calculate the surface area based on the monolayer adsorption.

To determine the BET surface area, a sample of the porous material is exposed to a specific gas, typically nitrogen, at different relative pressures. The amount of gas adsorbed at each pressure is measured. By plotting the adsorption isotherm and applying the BET equation, the surface area can be calculated. The BET surface area is expressed in units of square meters per gram (m²/g) and can provide valuable information about the material's pore size distribution, specific surface area, and adsorption capacity.

As shown above, embodiments of the present disclosure enable the production of an anode active material via a granulation method. The production of the anode active material from synthetic graphite may be performed without additional inorganic dopants, such as silicon dopants. Further, the production of the anode active material may be performed where the synthetic primary particles comprised of soft carbon have not been subjected to an oxidation treatment prior to the granulation process. Additional treatments, such as graphitization of the synthetic primary particles comprised of soft carbon, prior to granulation may not be necessary.

The anode active materials of the present disclosure may be tested with a battery half-cell. A battery half-cell is a type of electrochemical cell that consists of one of the two electrodes, typically the anode or the cathode, along with the electrolyte solution. The other electrode, known as the counter electrode, is not included in the half cell and is instead provided by the external circuit. Half cells are used in electrochemical experiments and measurements, where the behavior of a single electrode is studied in isolation. For example, a half cell can be used to measure the voltage of a particular electrode, or to study its electrochemical reactions. Half cells can also be used in practical applications, such as in the design and testing of battery systems. For example, a half cell can be used to measure the voltage and capacity of a particular electrode, which can be used to optimize the design of the overall battery system.

The anode materials produced herein may be incorporated into an electrochemical battery or cell. An electrochemical battery is a device that converts chemical energy into electrical energy and can be used to store and release electrical power. It consists of one or more electrochemical cells, each of which contains two electrodes and a solid or liquid electrolyte. When an electrical current is applied to the battery, chemical reactions occur at the electrodes, causing ions to flow through the electrolyte solution. This generates an electrical potential difference, or voltage, between the electrodes, and the battery is able to store and release electrical energy. The voltage generated by an electrochemical battery depends on the materials used for the electrodes and the electrolyte, as well as the concentration of the electrolyte solution and other factors. The overall reaction that occurs in the battery is a combination of the individual reactions that occur in each of the electrochemical cells. Electrochemical batteries are used in a wide range of applications, including portable electronic devices, such as smartphones and laptops, as well as cars, boats, and backup power systems. They are widely used because they are relatively small, lightweight, and rechargeable, making them well-suited for portable and mobile applications.

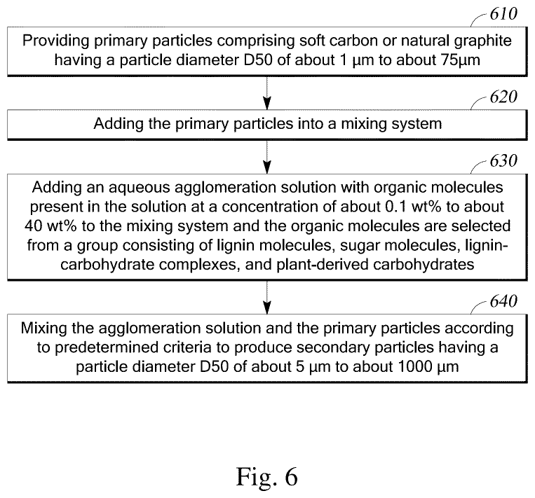

FIG. 6 is a flowchart of an example method for a method of making an electrochemical active material.

At step 610 is providing primary particles comprising soft carbon or natural graphite having a particle diameter D50 of about 1 μm to about 75 μm.

At step 620 is adding the primary particles into a mixing system.

At step 630 is adding an aqueous agglomeration solution with organic molecules present in the solution at a concentration of about 0.1 wt % to about 40 wt % to the mixing system and the organic molecules are selected from a group consisting of lignin molecules, sugar molecules, lignin-carbohydrate complexes, and plant-derived carbohydrates.

At step 640 is mixing the agglomeration solution and the primary particles according to predetermined criteria to produce secondary particles having a particle diameter D50 of about 5 μm to about 1000 μm.

The embodiments or examples disclosed herein may be recited in the non-limiting clauses below.

Clause 1. A method of making an electrochemical active material comprising: providing primary particles comprising soft carbon or natural graphite having a particle diameter D50 of about 1 μm to about 75 μm; adding the primary particles into a mixing system; adding an agglomeration solution with organic molecules present in the solution at a concentration of about 0.1 wt % to about 40 wt % to the mixing system and the organic molecules are selected from a group consisting of lignin molecules, sugar molecules, lignin-carbohydrate complexes, and plant-derived carbohydrates; and mixing the agglomeration solution and the primary particles according to predetermined criteria to produce secondary particles having a particle diameter D50 of about 5 μm to about 1000 μm.

Clause 2. The method of clause 1, wherein the primary particles are soft carbon selected from a group consisting of micronized petroleum coke powder, polyvinyl chloride, mesophase pitch, pitch coke, or coal coke.

Clause 3. The method of clause 1 or 2, wherein the organic molecules are sugar molecules, and the sugar molecules are present in the solution at a concentration of about 1 w t% to about 20 wt %.

Clause 4. The method of clause 1, 2, or 3, further comprising drying the secondary particles, wherein the organic molecules are present in the secondary particles at about 0.1 wt % to about 5 wt % on a dry weight basis.

Clause 5. The method of clause 1 or 2-4, wherein the mixing system is a high-shear mixing system or a fluidization system.

Clause 6. The method of clause 1 or 2-5, wherein a concentration of organic molecules is varied throughout the mixing whereby the organic molecule concentration is varied by a total agglomeration solution addition as a ratio of the primary particles used in agglomeration.

Clause 7. The method of clause 1 or 2-6, wherein the agglomeration solution has a pH in the range of about 7 to 10 and the organic molecules comprise at least one of ammonium lignosulfonate, sodium ligninsulfonate, soda lignin, dealkaline lignin, sucrose, ribose, riboside, glucose, glucoside, mannose, mannoside, galactose, galactoside, talitol, taloside, rhamnitol, rhamnoside, maltose, maltoside, lactoside, lactoside tetraacetate, 2,3-desoxy-2,3-dehydrolactoside, 2,3-desoxy-2,3-dehydrolactoside pentaacetate, 2,3-desoxylactoside, glucouronate, N-acetylglucosamine, fructose, sorbose, 2-deoxygalactose, 2-deoxyglucose, maltulose, lactulose, palatinose, leucrose, trehalose, gentiobiose, isomaltose, maltulose, turanose, lactose, mannitol, sorbitol, dulcitol, xylitol, 1-aminosorbitol, isomaltitol, cellobiitol, lactitol, maltitol, and fructose.

Clause 8. The method of clause 1, 2, 4-5, or 6, wherein the organic molecules are lignin molecules and comprise at least one of ammonium lignosulfonate, sodium ligninsulfonate, soda lignin, and dealkaline lignin.

Clause 9. The method of clause 1 or 2-8, wherein the primary particles have a particle diameter D50 between about 5 μm and about 15 μm and the secondary particles have a particle diameter D50 between about 10 μm and about 30 μm.

Clause 10. The method of clause 1 or 2-9, wherein the agglomeration solution is a homogeneous unsaturated solution.

Clause 11. The method of clause 1 or 2-10, wherein the secondary particles are one of spherical, oblong, oval, or almond shaped and have a BET surface area less than about 10 m²/g.

Clause 12. The method of clause 1 or 2-11, further comprising heating the secondary particles to form an electrochemical active material.

Clause 13. The method of clause 1 or 2-12, wherein the heating comprises carbonizing between about 800° C. and about 1200° C. followed by graphitizing between about 2600° C. and about 3000° C.

Clause 14. The method of clause 1 or 2-12, wherein the electrochemical active material comprises a matrix of soft carbon and hard carbon, wherein a ratio of soft carbon to hard carbon is between about 70:30 and about 99.5:0.5.

Clause 15. The method of clause 14, wherein the ratio of soft carbon to hard carbon is between about 97.5:2.5 and about 99.5:0.5.

Clause 16. The method of clause 1 or 2-14, wherein substantially all of the hard carbon content is derived from the hydrocarbon molecules.

Clause 17. The method of clause 1 or 2-12, wherein the electrochemical active material has a specific capacity greater than about 300 mAh/g in a battery half-cell.

Clause 18. The method of clause 12, wherein the electrochemical active material has a discharge capacity greater than about 340 mAh/g in a lithium-ion battery half-cell.

Clause 19. The method of clause 1 or 2-18, wherein both the primary particles and the secondary particles are not doped with additional inorganic particles.

Clause 20. The method of clause 1 or 2-19, wherein the predetermined criteria comprise one or more of a speed of a high-shear granulation pan, a speed of a high-shear granulation mixing rotor, a residence time in the mixing system, an airflow speed, a nozzle spray interval, and a nozzle spray volume.

Clause 21. The method of clause 1 or 2-20, wherein the agglomeration solution is sprayed into the mixture via a nozzle at a rate of about 12 mL/min per 500 grams of the primary particles and the agglomeration solution contains about 2 to about 30 wt % solids.

Clause 22. The method of clause 1 or 2-21, wherein the primary particles have not been subjected to an oxidation treatment or graphitization treatment prior to being added to the mixing system.

Clause 23. The method of clause 1, 3-12, or 16-22, wherein the primary particles are natural graphite.

Clause 24. The method of clause 1, 2-7, or 9-23, wherein the organic molecules are sugar molecules and comprise at least one of a plant-derived monosaccharide, disaccharide, and polysaccharide.

Clause 25. The method of clause 12, wherein the primary particles are natural graphite and the secondary particles are carbonized at a temperature of about 175-1200° C. without a graphitization step in excess of 1200° C.

Clause 26. An electrochemical active material comprising: an artificial secondary particle comprises one or more graphitized primary particles agglomerated together, the artificial secondary particles having a hard carbon content between about 0.25 wt % and about 4 wt %; and wherein the artificial secondary particle has a D50 between about 5 μm and about 50 microns; wherein the hard carbon content comprises carbonized organic molecules, the organic molecules selected from a group consisting of lignin molecules, sugar molecules, lignin-carbohydrate complexes, and plant-derived carbohydrates.

Clause 27. The electrochemical active material of clause 26, wherein the artificial secondary particle has a BET surface area less than about 10 m²/g.

Clause 28. The electrochemical active material of clause 26 or 27, wherein the organic molecules comprise at least one of monosaccharides, disaccharides, or polysaccharides.

Clause 29. A battery comprising: an anode active material produced according to clause 1, a cathode active material; and a liquid electrolyte.

Clause 30. The battery of clause 29, wherein the battery is a lithium-ion battery or a sodium ion battery.

Clause 31. A method of making an anode active material comprising: providing primary particles comprising soft carbon having a particle diameter D50 of about 1 μm to about 75 μm; adding the primary particles into a mixing system; adding an aqueous sugar solution to the mixing system, wherein the aqueous sugar solution is unsaturated solution containing sugar molecules; and mixing the aqueous sugar solution and the primary particles according to predetermined criteria to produce secondary particles having a particle diameter D50 of about 5 μm to about 1000 μm.

Clause 32. The method of clause 31, wherein the sugar molecules are present in the aqueous sugar solution at a concentration of about 1 wt % to about 90 wt %.

Clause 33. The method of clause 31, wherein the sugar molecules are present in the aqueous sugar solution at a concentration of about 1 wt% to about 10 wt%.

Clause 34. The method of clause 31 or 32, further comprising drying the secondary particles, wherein the sugar molecules are present in the secondary particles at about 3 wt % to about 20 wt % on a dry weight basis.

Clause 35. The method of clause 31, 32, or 34, wherein the sugar molecules comprise at least one of a plant-derived monosaccharide, disaccharide, and polysaccharide.

Clause 36. The method of clause 31, wherein the sugar solution has a concentration of about 1 wt % to about 10 wt %, the primary particles have a particle diameter D50 of about 5 μm to about 15 μm, and the secondary particles having a particle diameter D50 of about 10 μm to about 40 μm.

Clause 36a. The method of clause 31, 32, or 34-35, additionally comprising heating the secondary particles to carbonize the sugar molecules at a temperature of about 800° C. and about 1200° C. followed by graphitizing between about 2600° C. and about 3000° C.

Clause 37. The method of clause 31-34, or 36-36a, wherein the sugar molecules comprise at least one of a monosaccharide and a disaccharide.

Clause 38. An electrochemical active material comprising: a secondary particle comprising one or more graphitic primary particles agglomerated together, the secondary particles having a hard carbon content between about 0.25 wt % and about 4 wt %; and wherein the secondary particles have a D50 between about 5 μm and about 50 microns; wherein the hard carbon content comprises carbonized organic molecules selected from a group consisting of lignin molecules, sugar molecules, and plant-derived carbohydrates.

Clause 39. The electrochemical active material of clause 38, wherein the secondary particles have a BET surface area less than about 10 m²/g.

Clause 40. The electrochemical active material of clause 38 or 39, wherein the organic molecules comprise at least one of monosaccharides, disaccharides, or polysaccharides.

Clause 41. The electrochemical active material of clause 38 or 39-40, wherein the graphitic primary particles are natural graphite.

Clause 42. The electrochemical active material of clause 38 or 39-40, wherein the graphitic primary particles are synthetic graphite.

Clause 43. The electrochemical active material of clause 38 or 39-42 wherein the secondary particles have a D50 between about 5 μm and about 30 μm.

Clause 44. An anode active material comprising: a secondary particle comprising one or more graphitic primary particles agglomerated together via a carbonized hard carbon binder, the secondary particles having a hard carbon content between about 0.25 w t% and about 4 wt %; and wherein the secondary particles have a D50 between about 10 μm and about 30 microns; wherein the hard carbon binder content comprises carbonized organic molecules selected from a group consisting of sugar molecules and plant-derived carbohydrates.

Clause 45. The anode material of clause 44, wherein the secondary particles have a BET surface area less than about 10 m²/g.

Clause 46. The anode material of clause 44, wherein the secondary particles are composed of three or more primary particles agglomerated together via the carbonized hard carbon binder.

Clause 47. The anode material of clause 44 or 45, wherein the ratio of soft carbon to hard carbon is between about 97.5:2.5 and about 99.5:0.5.

Clause 48. The anode material of clause 44 or 45-47, wherein the secondary particles consist essentially of the graphitic primary particles and the hard carbon binder.

Clause 49. The anode material of clause 44 or 45-47, wherein the hard carbon binder is comprised of carbonized glucose, sucrose, or fructose.

Clause 50. The anode material of clause 44, 45-46, or 49, wherein the secondary particles consist exclusively of the graphitic primary particles and the hard carbon binder.

Clause 51. The anode material of clause 44, 45-49, wherein the secondary particles are free of inorganic molecules.

Clause 52. The anode material of clause 44, 45-49, wherein the secondary particles consist of graphitic carbon and carbonized carbon.

Clause 52. The anode material of clause 44, 45-49, wherein the secondary particles consist of carbon, oxygen, and hydrogen and exclude any other elements.

Clause 53. A method of making an anode active material for a lithium-ion battery, the method comprising: providing primary particles having an average or median diameter between about 1 μm and about 30 μm; providing an aqueous agglomeration solution comprising plant-derived molecules dissolved in a range from about 0.1 wt % to about 40 wt %; mixing the primary particles and the aqueous agglomeration solution to obtain secondary particles having an average or median diameter between about 5 μm and about 30 μm; and heating the secondary particles at a carbonization temperature to convert the plant-derived molecules to hard carbon.

Clause 54. The method of clause 53, wherein the plant-derived molecules are isolated from other organic matter.

Clause 55. The method of any one of clauses 53-54, wherein the agglomeration solution is provided continuously from a nozzle.

Clause 56. The method of any one of clauses 53-55, wherein the agglomeration solution is provided batch-wise.

Clause 57. The method of any one of clauses 53-56, wherein the particles are mixed in a high-shear mixing system.

Clause 58. The method of any one of clauses 53-57, wherein carbonization temperature is in the range of about 250 Celsius to 1200 Celsius.

Clause 59. The method of any one of clauses 53-58, wherein carbonization temperature is in the range of about 250 Celsius to 1200 Celsius.

Clause 60. The method of any one of clauses 53-59, additionally comprising graphitizing the secondary particles at a temperature of about 2600° C. to about 3000° C.

Clause 61. The method of any clauses 53-60, wherein the plant-derived molecules satisfy the chemical formula Cₙ(H₂O)ₙ, where “n” may be any positive integer.

Clause 62. The method of any clauses 53-61, wherein the water provided for the aqueous agglomeration solution has a TDS content of less than 200 PPM prior to dissolving the plant-derived molecules in the agglomeration solution.

Clause 63. The method of any clauses 53-61, wherein the plant-derived molecules are disaccharides.

Clause 64. The method of any clauses 53-61, wherein the plant-derived molecules are ammonium lignosulfonate.

Clause 65. The method of any one of clauses 53-64, wherein the particles are mixed in a high-shear mixing system and the speed of the mixing pan is varied at least twice throughout the mixing process.

Clause 66. The method of any one of clauses 53-65, wherein the high-shear mixing system is a batch high-shear system, in-line high-shear system, powder injection high-shear system, a high-shear granulator, or a powder injection high-shear mixer.

Clause 67. A method of making an anode active material for a lithium-ion battery, the method comprising: providing primary particles having an average or median diameter between about 1 μm and about 15 μm; providing a sugar solution comprising sugar molecules dissolved in a range from about 0.1 wt % to about 40 w t%; and mixing the primary particles and the aqueous agglomeration solution to obtain secondary particles having an average or median diameter between about 5 μm and about 30 μm.

Clause 68. The method of Clause 67, additionally comprising heating the secondary particles at a temperature of about 400 to 1200 degrees Celsius and graphitizing at a temperature of about 1800 to 3000 degrees Celsius.

Clause 69. The method of Clause 67, wherein the sugar solution comprises at least one of beet sugar, brown sugar, cane juice crystals, cane sugar, castor sugar, coconut sugar, confectioner's sugar, corn syrup solids, crystalline fructose, date sugar, demerara sugar, dextrin, diastatic malt, ethyl maltol, florida crystals, golden sugar, glucose syrup solids, grape sugar, maltodextrin, muscovado sugar, panela sugar, raw sugar, table sugar, sucanat, turbinado sugar, yellow sugar, agave nectar/syrup, barley malt, blackstrap molasses, brown rice syrup, buttered sugar/buttercream, carob syrup, corn syrup, evaporated cane juice, golden syrup, high-fructose corn syrup, honey, invert sugar, malt syrup, maple syrup, molasses, rice syrup, refiner's syrup, sorghum syrup, or treacle.

Clause 70. The method of Clause 68 or 69, wherein the sugar solution is substantially free of impurities.

Clause 71. The method of Clause 68 or 69-70, wherein the sugar solution consists essentially of water and molecules that satisfy the chemical formula Cₙ(H₂O)ₙ, where “n” may be any positive integer.

Clause 72. The method of any one of Clauses 68-71, wherein the secondary particles consist essentially of graphite and hard carbon.

Clause 73. The method of any one of Clauses 68-71, wherein the secondary particles consist exclusively of graphite and carbonized sugars, lignin, or carbohydrates.

### EXAMPLES

The following are exemplary in nature to better illustrate the present invention and are non-limiting in scope, application or uses.

Example 1—Micronized petroleum coke powder, polyvinyl chloride, mesophase pitch, pitch coke, or coal coke with a particle size sufficient for lithium-ion battery anode graphite are charged into a high-shear granulation system. These primary particles have an average size from about 5 to about 15 μm.

Lignin, sugar, or plant-derived carbohydrates, these comprising non-graphitizable carbons, are diluted to allow for proper formulation and processing, and in an embodiment the lignin, sugar, or plant-derived carbohydrate is dissolved such that the solution is unsaturated. The lignin, sugar, or plant-derived carbohydrates may be diluted between about 3 and about 15 wt %, is added to the solvent mixture at a known rate for blending in an incorporation step.

The lignin, sugar, or plant-derived carbohydrates may be utilized to adhere the primary particles to each other and hold through processing to maintain a secondary particle structure. The mass of the lignin, sugar, or plant-derived carbohydrates in the secondary particles may be greater than about 0.1% and less than about 10% on a dry weight basis.

Once the agglomeration solution or binder addition is complete, the high-shear system settings are adjusted to produce a granulated product ranging in average size from about 10 to about 30 μm. Adjustments include the speed of both the pan and mixing rotor, as well as the residence time at each mixing condition.

Residence time of the mixing is selected based on final degree of granulation and resulting agglomerate size and surface area. Agglomeration time is dependent on system parameters but ranges from about 5 to about 30 minutes. Oversized particles are removed via standard classification methods and can be downsized to the target size range.

The resulting graphitic/agglomeration molecule matrix is then carbonized between about 800 to about 1200° C. to harden the material into final form and produce the coke/hard carbon matrix.

Finally, the resulting particles may be graphitized from about 2600 to about 3000° C. to convert the coke structure to graphite and forming a final synthetic graphite/hard carbon secondary particle composite.

Example 2—Coke powder (derived from petroleum or coal tar) is micronized to have an average size from about 5 to about 15um.

Lignin, sugar, or plant-derived carbohydrates are diluted to allow for proper formulation and processing. The lignin, sugar, or plant-derived carbohydrate is diluted between about 2 and about 12 w t%, is added to the solvent at a known rate for blending in an incorporation step.

The coke powder is loaded into a fluidized bed granulation system and the bed is fluidized.

Aqueous lignin, sugar, or plant-derived carbohydrate binder may be added to the fluidized coke at a designated rate through a spray nozzle. The rate and total spray volume are determined by target particle size and generally results in a lignin, sugar, or plant-derived carbohydrates mass of about 0.1% to about 10% on a dry weight basis.

As the coke powder particles are coated with the sprayed agglomeration solution, they will begin to adhere to each other through the fluidization action. This can be performed in either a continuous or a batch fluidized bed granulator.

The process continues until the aggregated particles have achieved a desired size, preferably median particle diameter, D50, that is greater than about 5 μm and less than about 30 μm and a BET surface area less than about 10 m²/g.

Thereafter, the resulting agglomerated coke/agglomeration particle matrix is then carbonized between about 800-1200° C. to harden the material into final form and produce the coke/hard carbon matrix. Finally, the resulting particles are graphitized from about 2600 to about 3000° C. to convert the coke structure to graphite and form a final synthetic graphite/hard carbon secondary particle composite for use as an anode active material.

Example 3—In a fluidization test batch, the parameters of the fluidization apparatus may be configured to have a 10-12 wt % solids basis of agglomeration to precursor particles, a nozzle rate of 12 mL/min, a 200° F. set point, a 100-150° F. product temperature, a 100-300 surface feet per minute (sfpm) fluidization velocity, 10 psi pressure, a 2 L fluid bed, 500 g of petroleum coke precursor, 100 grams of 12% solids hard carbon agglomeration solution, and LS16 tubing. The batch may be configured to have a 1 hour processing time for pre-heating, dosing, and drying. The nozzle for coating is a 35100 air atomization nozzle.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±1%, ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein, but are to be accorded the widest scope consistent with this disclosure, the principles and the novel features disclosed herein.

1. A method of making an electrochemical material comprising:
providing primary particles comprising soft carbon or natural graphite;
adding the primary particles into a mixing system;
adding an aqueous agglomeration solution with organic molecules present in the solution at a concentration of about 0.1 wt % to about 40 wt % to the mixing system and the organic molecules are selected from a group consisting of lignin molecules, sugar molecules, lignin-carbohydrate complexes, and plant-derived carbohydrates; and
mixing the agglomeration solution and the primary particles according to predetermined criteria to produce secondary particles having a particle diameter D50 of about 5 μm to about 1000 μm.

2. The method of claim 1, wherein the primary particles are soft carbon selected from a group consisting of micronized petroleum coke powder, polyvinyl chloride, mesophase pitch, pitch coke, or coal coke.

3. The method of claim 1, wherein the organic molecules are sugar molecules and the sugar molecules are present in the solution at a concentration of about 1 wt % to about 20 wt %.

4. The method of claim 1, further comprising drying the secondary particles, wherein the organic molecules are present in the secondary particles at about 0.1 wt % to about 5 wt % on a dry weight basis.

5. The method of claim 1, wherein the mixing system is a high-shear mixing system or a fluidization system.

6. The method of claim 1, wherein a concentration of organic molecules is varied throughout the mixing by a total agglomeration solution addition as a ratio of the primary particles used in agglomeration.

7. The method of claim 1, wherein the agglomeration solution has a pH in the range of about 7 to 10 and the organic molecules comprise at least one of ammonium lignosulfonate, sodium ligninsulfonate, soda lignin, dealkaline lignin, sucrose, ribose, riboside, glucose, glucoside, mannose, mannoside, galactose, galactoside, talitol, taloside, rhamnitol, rhamnoside, maltose, maltoside, lactoside, lactoside tetraacetate, 2,3-desoxy-2,3-dehydrolactoside, 2,3-desoxy-2,3-dehydrolactoside pentaacetate, 2,3-desoxylactoside, glucouronate, N-acetylglucosamine, fructose, sorbose, 2-deoxygalactose, 2-deoxyglucose, maltulose, lactulose, palatinose, leucrose, trehalose, gentiobiose, isomaltose, maltulose, turanose, lactose, mannitol, sorbitol, dulcitol, xylitol, 1-aminosorbitol, isomaltitol, cellobiitol, lactitol, maltitol, and fructose.

8. The method of claim 1, wherein the organic molecules are lignin molecules and comprise at least one of ammonium lignosulfonate, sodium ligninsulfonate, soda lignin, and dealkaline lignin.

9. The method of claim 1, wherein the primary particles have a particle diameter D50 between about 5 μm and about 15 μm and the secondary particles have a particle diameter D50 between about 10 μm and about 30 μm.

10. The method of claim 1, wherein the agglomeration solution is an unsaturated solution.

11. The method of claim 9, wherein the secondary particles are one of spherical, oblong, oval, or almond shaped and have a BET surface area less than about 10 m²/g.

12. The method of claim 1, further comprising heating the secondary particles to form an electrochemical active material.

13. The method of claim 12, wherein the heating comprises carbonizing between about 800° C. and about 1200° C. followed by graphitizing between about 2600° C. and about 3000° C.

14. The method of claim 12, wherein the electrochemical active material comprises a matrix of soft carbon and hard carbon, wherein a ratio of soft carbon to hard carbon is between about 70:30 and about 99.5:0.5.

15. The method of claim 14, wherein the ratio of soft carbon to hard carbon is between about 97.5:2.5 and about 99.5:0.5.

16. The method of claim 14, wherein substantially all of the hard carbon content is derived from the organic molecules.

17. The method of claim 12, wherein the electrochemical active material has a specific capacity greater than about 300 mAh/g in a battery half-cell.

18. The method of claim 12, wherein the electrochemical active material has a discharge capacity greater than about 340 mAh/g in a lithium-ion battery half-cell.

19. The method of claim 1, wherein both the primary particles and the secondary particles are not doped with additional inorganic particles.

20. The method of claim 1, wherein the predetermined criteria comprise one or more of a speed of a high-shear granulation pan, a speed of a high-shear granulation mixing rotor, a residence time in the mixing system, an airflow speed, a nozzle spray interval, and a nozzle spray volume.

21. The method of claim 1, wherein the agglomeration solution is sprayed into the mixture via a nozzle at a rate of about 12 mL/min per 500 grams of the primary particles and the agglomeration solution contains about 2 to about 30 wt % solids.

22. The method of claim 1, wherein the primary particles have not been subjected to an oxidation treatment or graphitization treatment prior to being added to the mixing system.

23. The method of claim 1, wherein the primary particles are natural graphite.

24. The method of claim 1, wherein the organic molecules are sugar molecules and comprise at least one of a plant-derived monosaccharide, disaccharide, and polysaccharide.

25. An electrochemical active material comprising:
an artificial secondary particle comprising one or more graphitized primary particles agglomerated together, the artificial secondary particles having a hard carbon content between about 0.2 wt % and about 4 wt %; and
wherein the artificial secondary particles have a D50 between about 5 μm and about 50 μm;
wherein the hard carbon content comprises carbonized organic molecules and the organic molecules are selected from a group consisting of lignin molecules, sugar molecules, lignin-carbohydrate complexes, and plant-derived carbohydrates.

26. The electrochemical active material of claim 25, wherein the artificial secondary particle has a BET surface area less than about 10 m²/g.

27. The electrochemical active material of claim 25, wherein the organic molecules comprise at least one of monosaccharides, disaccharides, or polysaccharides.

28. A battery comprising:
an anode active material produced according to claim 1,
a cathode active material; and
a liquid electrolyte.

29. The battery of claim 28, wherein the battery is a lithium-ion battery or a sodium ion battery.
